(19) United States
(12) Patent Application Publication
(10) Pub. No.: US 2004/0003663 A1
(43) Pub. Date: Jan. 8, 2004

(54) Method and device for checking workpieces

(75) Inventors: Thomas Dibos, Monschau (DE); Karl-Heinz Wuller, Simmerath (DE)

Correspondence Address: LEYDIG VOIT & MAYER, LTD, TWO PRUDENTIAL PLAZA, SUITE 4900, 180 NORTH STETSON AVENUE, CHICAGO, IL, 60601-6780, US

(73) Assignee: Durr Ecoclean GmbH, Filderstadt (DE)

(21) Appl. No.: 10/456,773

(22) Filed: Jun. 6, 2003

Related U.S. Application Data
(63) Continuation of application No. PCT/EP02/11630, filed on Oct. 17, 2002.

(30) Foreign Application Priority Data
Oct. 25, 2001 (DE) 101 52 795.0

(51) Int. Cl. G01N 29/14

(52) U.S. Cl. 73/587; 73/37

(57) ABSTRACT

In order to create a method for checking workpieces with at least one interior space, which is easy and quick to carry out, it is proposed that the method comprises the following steps:

a. generating a flow of gas in the interior space of the workpiece;

b. detecting a noise generated by the flow of gas;

c. comparing a measured value derived from the noise with a desired value.

### BACKGROUND OF INVENTION

The present invention relates to a method and a device for checking workpieces with at least one interior space.

A checking method of this kind serves in particular to establish the presence of foreign bodies present in the interior space of the workpiece, so these foreign bodies can subsequently be removed from the workpiece.

In a known method for checking workpieces for foreign bodies located therein a visual check is carried out by means of a flexible endoscope, wherein the endoscope has to be inserted manually into the interior space of the workpiece to be checked. A visual and manual checking method of this kind cannot be automated and is very time-consuming, so it is normally not possible to check all the hollow spaces inside the workpiece in the cycle times preset in industrial production, so checking has to be restricted to random examination.

Therefore the object of the present invention is to create a method for checking workpieces with at least one interior space, which can be easily and quickly carried out.

### BRIEF DESCRIPTION ON INVENTION

This object is achieved according to the invention by a method for checking workpieces with at least one interior space, comprising the following method steps:

a. generating a flow of gas in the interior space of the workpiece;

b. detecting a noise generated by the flow of gas;

c. comparing a measured value derived from the noise with a desired value.

The concept behind the solution according to the invention is thus to carry out acoustic checking of the workpiece, wherein a flow of gas is conducted through the hollow spaces and contours of the workpiece to be checked in such a way that a specific noise pattern emerges for each workpiece and each site subjected to the flow.

The noise pattern thus generated is substantially the same with identical supply of gas and with identical components (in particular with regular components without foreign bodies contained in them).

A divergence from the desired noise pattern indicates that in the area of the workpiece respectively subjected to the flow there is a divergence from the circumstances in a regular workpiece.

A workpiece with a diverging noise pattern is removed as irregular and taken to a subsequent working area for reworking.

In this subsequent working area the foreign body contained in the workpiece can be removed, for example, by the known visual and manual method.

Locating the foreign body can be done by the visual and manual method or even, as will be explained, by the acoustic method according to the invention.

The checking method according to the invention can be carried out fully automatically.

In addition, the introduction of the workpieces to be checked into the checking device in which the method is carried out and taking out the workpieces and also the possibly resulting removal of the workpieces found to be irregular from the further processing path can be automated.

The method according to the invention is particularly suitable for detecting residual chips in a workpiece after metal-cutting processing and subsequent cleaning of the workpiece.

The gas, by the flow of which the specific noise is generated, can enter the interior space of the workpiece through an inlet orifice and exit the workpiece again through an outlet orifice different from the inlet orifice.

It can, however, also be provided that the inlet and the outlet orifices are identical to one another. In this way the method according to the invention can also be used for checking blind holes or other interior spaces in the workpiece which have only one access orifice.

Basically any gas or gas mixture can be considered for generating the flow of gas.

The method is, however, easiest to carry out if the flow of gas generated is a flow of air.

In a preferred configuration of the method it is provided that to generate the flow of gas a gas is supplied to the interior space at an excess pressure of at least 50 mbar, preferably of at least 100 mbar, relative to the ambient pressure.

The flow of gas is advantageously generated by a fan, in particular by a side channel compressor.

Alternatively or as a supplement to this, it can also be provided that the gas is supplied to the interior space of the workpiece from a compressed air reservoir, for example a compressed air cylinder, or from an installed compressed air supply.

In a preferred configuration of the invention it is provided that to generate the flow of gas a gas is supplied to an inlet orifice of the interior space via a supply line.

The supply line can in particular be provided with an outlet widening towards the inlet orifice.

In order to achieve as few losses as possible occurring during the transition of the gas from the supply line into the interior space of the workpiece, it is more advantageously provided that the supply line is provided with a bush comprising an elastic material. This guarantees that the bush can fit the outer face of the workpiece surrounding the inlet orifice and in this way can enclose the inlet orifice on the workpiece as substantially gastight.

The noise generated by the flow of gas is detected by a sound sensor, preferably by a microphone or a structure-borne sound sensor.

In this description and the attached claims a measured value is to be understood not only as a scalar quantity, but also as a one- or multi-dimensional measured value field or else a one- or multi-dimensional continuous function.

In particular it can be provided that a frequency spectrum of the noise is determined as measured value.

This frequency spectrum can be in the audible and/or non-audible frequency range (infra- or ultrasound).

It has proved particularly favourable to determine the frequency spectrum in a frequency range between 0 and approximately 22,000 Hertz.

Also, in this description and the attached claims a desired value is to be understood not only as a scalar quantity, but also as a one- or multidimensional desired value field or else a one- or multi-dimensional continuous function.

In particular it can be provided that a frequency spectrum is determined as desired value.

In order to reduce the influence of static noise, it is preferably provided that the desired value is determined by averaging over measurements on a plurality of regular workpieces.

Alternatively or as a supplement to this, it could also be provided that the desired value is not experimentally determined by carrying out measurements on workpieces (“taught”), but calculated theoretically.

In a preferred configuration of the method according to the invention it is provided that a desired frequency spectrum is determined as desired value and a measured frequency spectrum as measured value.

In particular it can be provided that a workpiece is rejected as irregular if the divergence between the measured frequency spectrum and the desired frequency spectrum at at least one frequency is greater than a preset tolerance value.

In order to reduce the influence of static noise, alternatively or as a supplement to this it can be provided that a workpiece is rejected as irregular if the divergence between the measured frequency spectrum and the desired frequency spectrum is greater than a preset tolerance value over a preset frequency range.

It can further be provided that a workpiece is rejected as irregular if the average divergence between the measured frequency spectrum and the desired frequency spectrum is greater than a preset tolerance value over a preset frequency range.

In order to achieve that the flow of gas in the interior space of the workpiece detects particularly interesting areas of the workpiece, while other areas are not, or to a lesser extent, flowed through, it can be provided that at least one outlet orifice of the workpiece is covered during detecting of the noise generated by the flow of gas. This prevents the gas flowing out through the outlet orifice concerned, so the noise generated by the flow of gas is substantially generated by hollow spaces in the workpiece which end at a different outlet orifice.

In particular it can be provided that the outlet orifice is covered by a covering element which is movable relative to the workpiece.

This covering element can in particular be moved relative to the workpiece pneumatically and/or hydraulically, enabling automation of the method according to the invention.

In order better to be able to locate a possible divergence from the normal state of the workpiece to be checked, in a preferred configuration of the method according to the invention it is provided that the noise generated by the flow of gas is detected both when the outlet orifice is covered and when the outlet orifice is not covered (in the former case it can be provided that the gas flows out through a different outlet orifice of the workpiece). By changing the permeability of the outlet orifice the configuration of the flow of gas generated in the interior space of the workpiece is changed, leading to the fact that in each of the various configurations in each case different areas of the interior space of the workpiece contribute to a particular extent to the noise pattern generated by the flow of gas. By changing the configuration of the flow of gas, various areas of the interior space of the workpiece can thus be tested in succession for irregularities, in particular foreign bodies, and therefore any foreign bodies present can be located.

It can in particular be provided that several coverable outlet orifices are present and several noise-detecting steps are carried out, wherein for each noise-detecting step a different subset of the coverable outlet orifices is opened.

If in this case in one of the noise-detecting steps a significant divergence of the measured value from the associated desired value is detected, from the configurations of outlet orifices present in the noise-detecting step concerned the area in which the divergence from the normal state, in particular the foreign body, appears can be determined.

The information about which area is concerned can be communicated to a control unit, stored on a data carrier, output on a display unit and/or indicated on the workpiece itself by appropriate marking of the area concerned.

During subsequent working on an irregular workpiece this information can then be used to examine and/or clean specifically only the partial area of the irregular workpiece.

Particularly precise locating of an established irregularity is possible if for each noise-detecting step precisely one of the coverable outlet orifices is opened. In this case the noise generated is significantly determined by the area of the interior space of the workpiece adjoining the opened outlet orifice.

It can further be provided that several noise-detecting steps are carried out in succession on the same workpiece, in order to be able to check interior spaces of the workpiece separated from one another.

In this case the gas for generating the flow of gas is preferably supplied to the workpiece in succession via various inlet orifices.

The invention is based on the further object of creating a device for checking workpieces with at least one interior space, which allows easy and quick checking of the workpieces.

This object is achieved according to the invention by a device for checking workpieces with at least one interior space, comprising a gas flow generating device for generating a flow of gas in the interior space of the workpiece, a noise-detecting device for detecting a noise generated by the flow of gas and a processing device which derives a measured value from the noise and compares the derived measured value with a desired value.

In particular the device according to the invention can comprise a control unit which drives the various components of the checking device and in this way enables automatic execution of the checking method with the checking device.

Particular configurations of the device according to the invention are the subject of dependent claims 24 to 31, the advantages of which have already been explained above in connection with the particular configurations of the method according to the invention.

Further features and advantages of the invention are the subject of the following description and graphic illustration of embodiments.

### BRIEF DESCRIPTION OF THE DRAWINGS

FIG. 1 shows a schematic illustration of a checking device and a regular workpiece;

FIG. 2 shows a diagram illustrating a frequency spectrum averaged by measuring on a plurality of regular workpieces;

FIG. 3 shows a schematic illustration of the checking device from FIG. 1 with an irregular workpiece;

FIG. 4 shows a diagram illustrating the frequency spectrum obtained from an irregular workpiece;

FIG. 5 shows a diagram illustrating the frequency spectrum obtained on a regular workpiece and the frequency spectrum obtained from an irregular workpiece;

FIG. 6 shows a checking device, with which several channels of a workpiece can be checked, in a first detecting step for checking a first channel of the workpiece;

FIG. 7 shows an illustration corresponding to FIG. 6 in a second detecting step for examining a second channel;

FIG. 8 shows an illustration corresponding to FIG. 6 in a third detecting step for examining a third channel; and

FIG. 9 shows an illustration corresponding to FIG. 6 in a fourth detecting step for examining a fourth channel.

Identical or functionally equivalent elements are designated in all the figures by the same reference numerals.

### DETAILED DESCRIPTION OF THE INVENTION

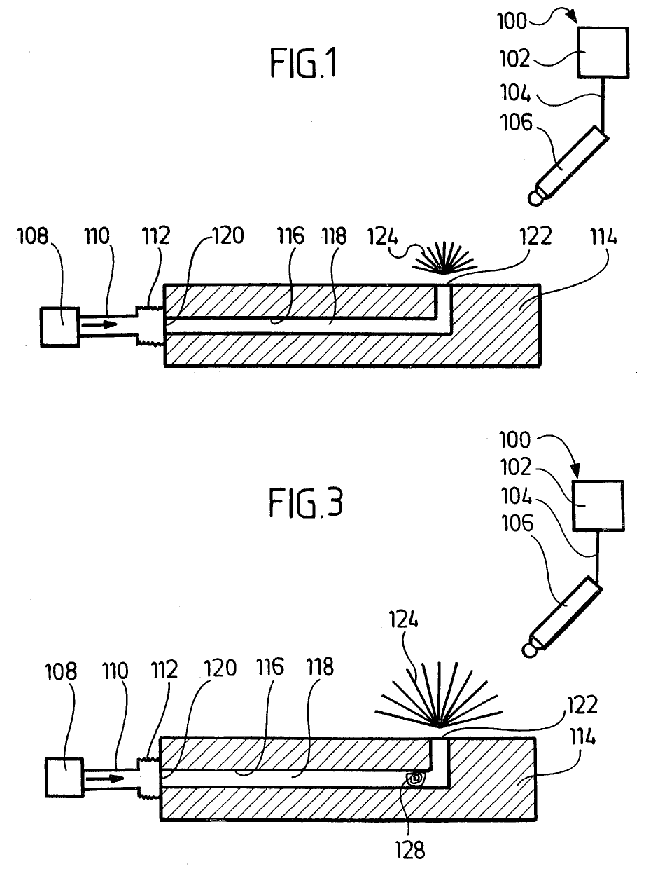

A checking device illustrated in FIGS. 1 and 3 and designated as an entirety as 100 comprises a control unit 102, connected to a microphone 106 via a signal line 104, and also a fan 108, connected to a bush 112 via a supply line 110.

A workpiece 114 to be checked by the checking device 100, which has an interior space 118, constructed as a channel 116, with an inlet orifice 120 and an outlet orifice 122, can be brought by means of suitable conveying and/or handling devices (not shown) into the checking position illustrated in FIG. 1, in which the microphone 106 of the checking device 100 is arranged on the side of the workpiece 114 having the outlet orifice 122 and is preferably directed towards the outlet orifice 122.

The bush 112 closing off the supply line 110 is movable relative to the workpiece 114, by means of suitable handling devices (not shown), which are preferably controlled by the control unit 102, in such a way that the bush 112 rests against the side of the workpiece 114 having the inlet orifice 120 by way of a seal and therein overlaps the inlet orifice 120 in such a way that the interior space 118 is connected to the supply line 110 via the interior space of the bush 112.

For this purpose the supply line 110 is preferably constructed as flexible.

The bush 112 further preferably comprises an elastic material, rubber for example.

The cross-section of the bush 112 which can be flowed through is larger than the cross-section of the supply line 110 which can be flowed through.

After the bush 112 has been moved up to the workpiece 114, by means of the fan 108, which can be constructed, for example, as a side channel compressor, a flow of air is generated through the supply line 110 and the channel 116 of the workpiece 114 connected to it.

The air supplied to the interior space 118 of the workpiece 114 has, for example, an excess pressure of approximately 200 mbar with respect to the atmospheric pressure.

The throughput of the flow of air is, for example, 800 m3/h.

The speed of flow in the supply line 110 is, for example, 230 m/s.

The thus generated flow of air through the channel 116 generates a whistling noise, which spreads out from the outlet orifice 122 in the form of spherical waves—as indicated in FIG. 1 by the lines 124—and so reaches the microphone 106.

In the microphone 106 the arriving acoustic waves are converted into electric pulsations, which are transmitted to the control unit 102 by the signal line 104 and there converted into digital data by an A/C converter.

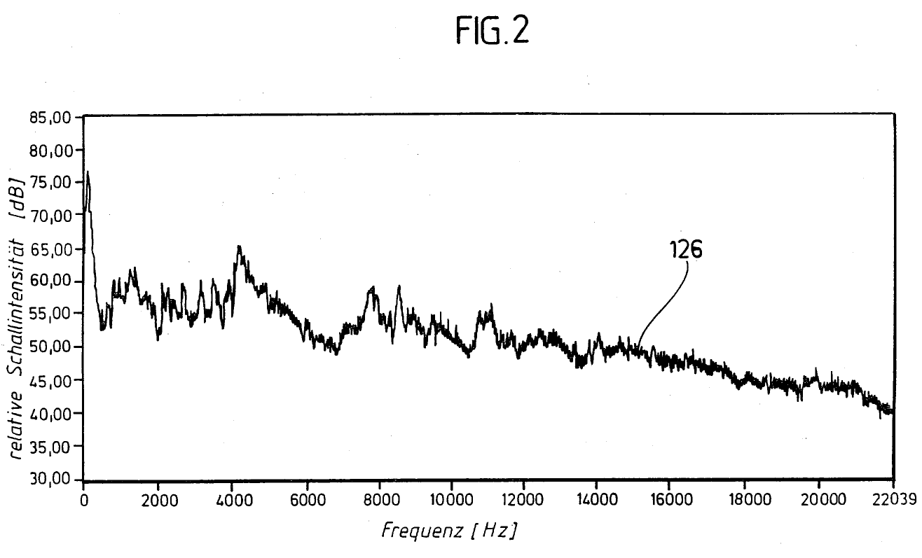

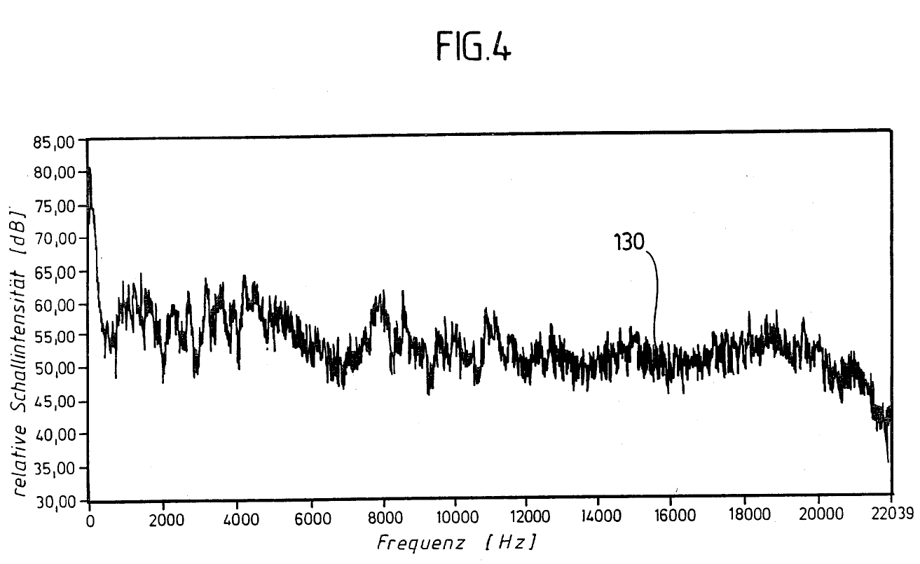

The thus generated time-dependent signal is transformed in the control unit 102, which can be constructed, for example, as a programmable microcomputer, by a Fourier transformation, preferably a fast Fourier transformation (FFT) into a frequency spectrum of the kind illustrated in FIG. 2.

As can be seen in FIG. 2, the frequencies are preferably detected in the range of 0 to 22,000 Hertz, i.e. predominantly frequencies in the range audible to the human ear.

The diagram of FIG. 2 is a double-logarithmic illustration in which the relative sound intensity is represented in dB over the frequency in Hertz.

If the workpiece 114 to be checked is regular, i.e. the channel 116 does not contain any foreign bodies, the frequency spectrum obtained by the measurement and the subsequent Fourier transformation—apart from a static noise—corresponds to the desired frequency spectrum 126 illustrated in FIG. 2.

This desired frequency spectrum 126 is obtained in that by means of the checking device 100 in each case a plurality of frequency spectra is determined on a plurality of regular workpieces 114 and averaging of all the frequency spectra obtained in this way is carried out, in order to reduce the static noise.

The desired frequency spectrum 126 illustrated in FIG. 2 has therefore been determined in that in each case 10 frequency spectra have been determined by measuring on six different regular workpieces and then an average has been taken of the 60 frequency spectra obtained.

The measured frequency spectrum determined on the workpiece 114 to be checked is compared with the desired frequency spectrum 126.

If the workpiece 114 to be checked, as illustrated in FIG. 1, is a regular workpiece, this average divergence between the measured frequency spectrum and the desired frequency spectrum 126 is substantially zero over the entire frequency range detected.

The checked workpiece 114 is in this case released as regular by the control unit 102 for further processing and moved out of the checking device 100 and supplied to further processing.

If, however, the checked workpiece 114 is a workpiece which, for example owing to the presence of a foreign body 128, for example a chip, in the channel 116, is an irregular workpiece (as illustrated in FIG. 3), the measured frequency spectrum 130 determined on this workpiece 114 shows significant divergences from the desired frequency spectrum 126, at least in a partial area of the frequency range detected.

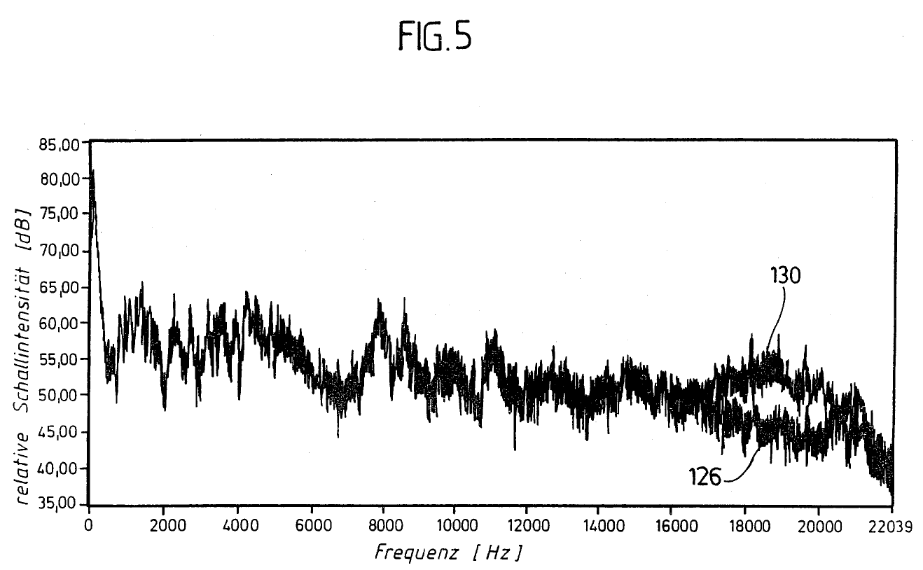

From FIG. 5, in which the measured frequency spectrum 130 of an irregular workpiece and the desired frequency spectrum 126 of a workpiece are compared with one another, it can be seen that both frequency spectra in fact substantially agree with one another in the range of 0 to approximately 16,000 Hertz, but in the range of approximately 16,000 Hertz to approximately 21,000 Hertz the measured frequency spectrum 130 of the irregular workpiece is considerably above the desired frequency spectrum 126.

If the divergence of the measured frequency spectrum 130 of a workpiece 114 to be checked from the desired frequency spectrum 126 in a frequency range with an extent of 1,000 Hertz is above a preset threshold value, for example 3 dB, the workpiece 114 concerned is rejected as irregular.

In this case the checked workpiece 114 is moved out of the checking device 100, but not supplied to further processing, but instead set apart and taken into a subsequent working area, in which manual re-checking and, if necessary, removal of the foreign body 128 from the interior space 118 of the workpiece 114 is carried out.

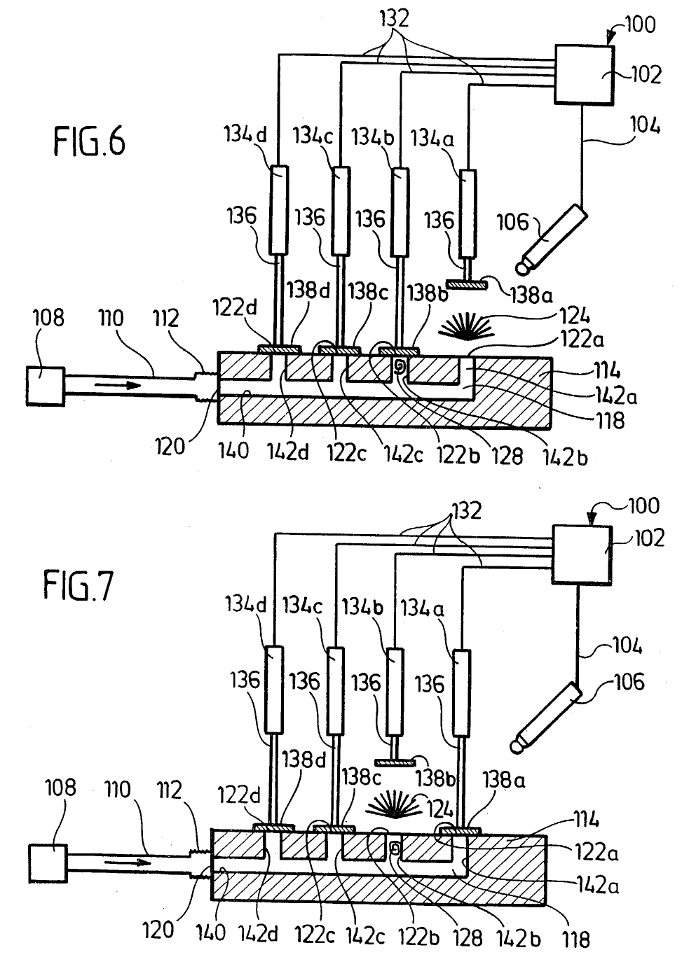

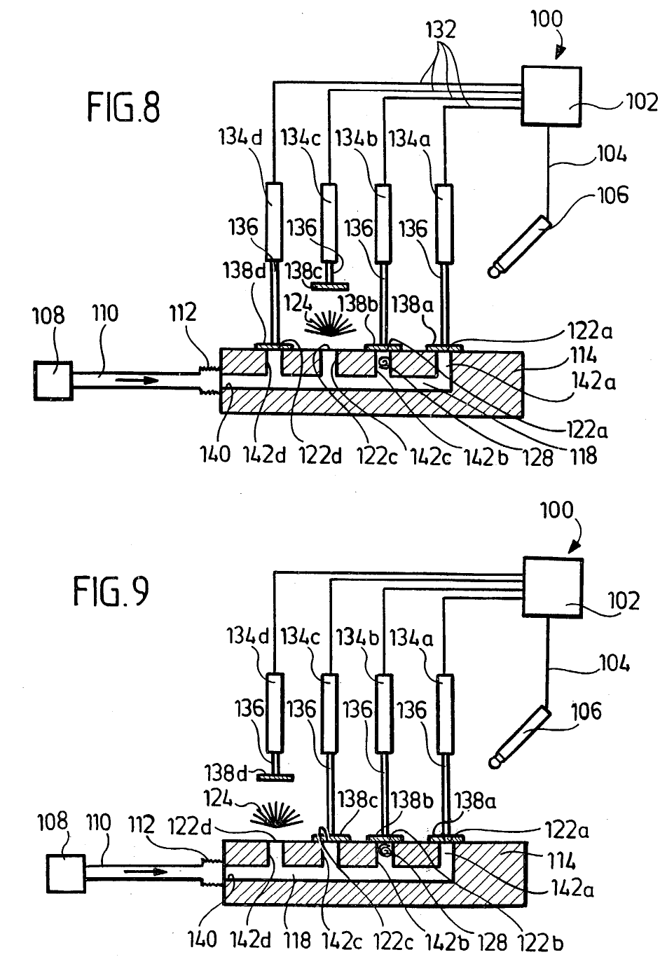

A second embodiment of a checking device 100 illustrated in FIGS. 6 to 9 differs from the previously described first embodiment in that it enables several channels, of a workpiece 114 to be checked, to be checked in succession for the presence of foreign bodies and thus any foreign bodies 128 present in the workpiece 114 to be located.

The second embodiment of a checking device 100, like the first embodiment, comprises a control unit 102 connected to a microphone 106 via a signal line 104 and also a fan 108 connected to a bush 112 via a supply line 110.

The checking device 100 further comprises several, for example four, pneumatic cylinders 134a to 134d, connected to the control unit 102 via control lines 132, in which pistons (not illustrated) are displaceably contained, which are connected to a covering plate 138a to 138d respectively via a rod 136 in each case.

By means of the pneumatic cylinder 134a to 134d allocated in each case each of the pistons is displaceable between a first end position, in which the respectively allocated covering plate 138a to 138d covers one of the outlet orifices 122a to 122d of the workpiece 114 so as to be airtight, and a second end position, in which the respectively allocated covering plate 138a to 138d opens the associated outlet orifice 122a to 122d.

The workpiece 114 to be checked has in this case a main channel 140, connected in the checking position of the workpiece 114 illustrated in FIGS. 6 to 9 to the supply line 110 via the inlet orifice 120 and the bush 112, and several subsidiary channels 142a to 142d, branching off from the main channel 140 and ending at one of the outlet orifices 122a to 122d in each case.

For carrying out the checking process on the workpiece 114 to be checked the pistons in all the pneumatic cylinders 134a to 134d are first brought by suitable control commands of the control unit 102 into their first end position, in which the associated covering plate 138a to 138d overlaps by way of a seal the respectively allocated outlet orifice 122a to 122d, so no air can escape from the outlet orifice concerned.

The fan 108 is taken into operation to supply air to the workpiece 114 to be checked at an excess pressure of approximately 200 mbar.

Then in a first noise-detecting step pneumatic cylinder 134a is actuated by the control unit 102 in such a way that the piston in pneumatic cylinder 134a is moved into its second end position in which the allocated covering plate 138a opens outlet orifice 122a of subsidiary channel 142a. In this way the air supplied by the supply line 110 can flow through the main channel 140 and subsidiary channel 142a and escape through outlet orifice 122a.

This flow causes a whistling noise, which spreads out from outlet orifice 122a in the form of spherical waves and is detected by the microphone 106 in the way already described above.

The noise thus detected and allocatable to subsidiary channel 142a is digitised in the control unit 102 and Fourier transformed, in order to obtain a measured frequency spectrum allocated to subsidiary channel 142a, which is compared with a desired frequency spectrum allocated to subsidiary channel 142a.

In the case illustrated in FIG. 6 subsidiary channel 142a does not contains a foreign body, so the measured frequency spectrum obtained in the first noise-detecting step substantially agrees with the desired frequency spectrum for subsidiary channel 142a.

After detecting the noise generated by the flow of air through subsidiary channel 142a, covering plate 138a is again moved towards the workpiece 114 to be checked by actuating pneumatic cylinder 134a, in order to close outlet orifice 122a of subsidiary channel 142a.

Then a second noise-detecting step is carried out, corresponding to the first noise-detecting step, with the exception that instead of the first covering plate 138a from now on the second covering plate 138b is moved away from outlet orifice 122b of subsidiary channel 142b by actuating pneumatic cylinder 134b.

This causes a flow of air through the main channel 140 and subsidiary channel 142b, by which a whistling noise is generated which spreads out from outlet orifice 122b to the microphone 106 and is detected and further processed in the way already described above.

As, in the example case discussed here, there is a foreign body 128, for example a chip, in subsidiary channel 142b, the measured frequency spectrum allocated to subsidiary channel 142b diverges in a significant way from the desired frequency spectrum allocated to this subsidiary channel.

The second noise-detecting step is ended by closing outlet orifice 122b by moving up covering plate 138b by actuating pneumatic cylinder 134b.

Then a third noise-detecting step, in which outlet orifice 122c is opened and a measured frequency spectrum allocated to subsidiary channel 142c is determined, and a fourth noise-detecting step, in which outlet orifice 122d is opened and a measured frequency spectrum allocated to subsidiary channel 142d is determined, are carried out in succession analogously to the way described for the first and second noise-detecting steps.

As the comparison of the measured frequency spectrum for the second subsidiary channel 142b with the desired frequency spectrum allocated to the same subsidiary channel resulted in a significant divergence, the workpiece 114 to be checked is set apart as irregular and conveyed out of the checking device 100 into the subsequent working area.

The control unit 102 communicates to a display unit (not illustrated) the message that the second subsidiary channel 142b is irregular. The manual subsequent working, in particular searching for a foreign body and removal thereof can therefore be confined to this subsidiary channel of the workpiece 114.

If there were a foreign body in the main channel 140 of the workpiece 114, for example in the section connecting the branching points of the second subsidiary channel 142b and the third subsidiary channel 142c, the measured frequency spectra of several subsidiary channels, for example of the first subsidiary channel 142a and the second subsidiary channel 142b, would diverge from the respectively associated desired frequency spectra. In this case the control unit 102 would communicate to the display unit the message that several subsidiary channels, for example, subsidiary channels 142a and 142b, are irregular.

The person carrying out the subsequent work can conclude from a message of this kind that either foreign bodies are present in both subsidiary channel 142a and subsidiary channel 142b, or that there is at least one foreign body in the section of the main channel 140 located in front of the two subsidiary channels 142a, 142b in the flow direction.

Otherwise the second embodiment of a checking device 100 coincides in respect of structure and function with the first embodiment and reference is made to this extent to the above description thereof.

1. Method for checking workpieces (114) with at least one interior space (118), comprising the following method steps:
generating a flow of gas in the interior space (118) of the workpiece (114);
detecting a noise generated by the flow of gas;
comparing a measured value derived from the noise with a desired value.

2. Method according to claim 1, characterised in that the flow of gas generated is a flow of air.

3. Method according to one of claims 1 or 2, characterised in that a gas is supplied to the interior space (118) at an excess pressure of at least 50 mbar, preferably of at least 100 mbar.

4. Method according to one of claims 1 to 3, characterised in that the flow of gas is generated by a fan (108).

5. Method according to one of claims 1 to 4, characterised in that a gas is supplied to an inlet orifice (120) of the interior space via a supply line (110).

6. Method according to claim 5, characterised in that the supply line (110) is provided with an outlet widening towards the inlet orifice (120).

7. Method according to one of claims 5 or 6, characterised in that the supply line (110) is provided with a bush (112) comprising an elastic material.

8. Method according to one of claims 1 to 7, characterised in that the noise is detected by a microphone (106) or a structure-borne sound sensor.

9. Method according to one of claims 1 to 8, characterised in that a frequency spectrum of the noise is determined as measured value.

10. Method according to claim 9, characterised in that the frequency spectrum is determined in a frequency range between 0 and approximately 22,000 Hertz.

11. Method according to one of claims 1 to 10, characterised in that a frequency spectrum is determined as desired value.

12. Method according to one of claims 1 to 11, characterised in that the desired value is determined by averaging over measurements on a plurality of regular workpieces.

13. Method according to one of claims 1 to 12, characterised in that a desired frequency spectrum is determined as desired value and a measured frequency spectrum as measured value.

14. Method according to claim 13, characterised in that a workpiece (114) is rejected as irregular if the divergence between the measured frequency spectrum and the desired frequency spectrum at at least one frequency is greater than a preset tolerance value.

15. Method according to one of claims 13 or 14, characterised in that a workpiece (114) is rejected as irregular if the divergence between the measured frequency spectrum and the desired frequency spectrum is greater than a preset tolerance value over a preset frequency range.

16. Method according to one of claims 1 to 15, characterised in that at least one outlet orifice (122a to 122d) of the workpiece (114) is covered during detecting of the noise generated by the flow of gas.

17. Method according to claim 16, characterised in that the outlet orifice (122a to 122d) is covered by a covering element (138a to 138d) movable relative to the workpiece (114).

18. Method according to claim 17, characterised in that the covering element (138a to 138d) is moved relative to the workpiece (114) pneumatically and/or hydraulically.

19. Method according to one of claims 16 to 18, characterised in that the noise generated by the flow of gas is detected both when the outlet orifice (122a to 122d) is covered and when the outlet orifice (122a to 122d) is not covered.

20. Method according to claim 19, characterised in that there are several coverable outlet orifices (122a to 122d) and several noise-detecting steps are carried out, wherein a different subset of coverable outlet orifices (122a to 122d) is opened for each noise-detecting step.

21. Method according to claim 20, characterised in that precisely one of the coverable outlet orifices (122a to 122d) is opened for each noise-detecting step.

22. Method according to one of claims 1 to 21, characterised in that several noise-detecting steps are carried out in succession on the same workpiece (114).

23. Device for checking workpieces (114) with at least one interior space (118), comprising
a gas flow generating device for generating a flow of gas in the interior space (118) of the workpiece (114);
a noise-detecting device for detecting a noise generated by the flow of gas and
a processing device which derives a measured value from the noise and compares the derived measured value with a desired value.

24. Device according to claim 23, characterised in that the gas flow generating device comprises a fan (108).

25. Device according to one of claims 23 or 24, characterised in that the gas flow generating device comprises a supply line (110) for supplying a gas to an inlet orifice (120) of the interior space (118) of the workpiece (114).

26. Device according to claim 25, characterised in that the supply line (110) is provided with an outlet widening towards the inlet orifice (120).

27. Device according to one of claims 25 or 26, characterised in that the supply line (110) is provided with a bush (112) comprising an elastic material.

28. Device according to one of claims 23 to 27, characterised in that the noise-detecting device comprises a microphone (106) or a structure-borne sound sensor.

29. Device according to one of claims 23 to 28, characterised in that the device (100) comprises at least one covering element (138a to 138d) for covering at least one outlet orifice (122a to 122d) of the workpiece (114).

30. Device according to claim 29, characterised in that the covering element (138a to 138d) is movable relative to the workpiece (114).

31. Device according to claim 30, characterised in that the device (100) comprises a pneumatic and/or hydraulic movement device for moving the covering element (138a to 138d) relative to the workpiece (114).
